(19) United States
(12) Patent Application Publication
(10) Pub. No.: US 2007/0262763 A1
(43) Pub. Date: Nov. 15, 2007

(54) Power supply circuit device and electronic apparatus provided therewith

(75) Inventor: Tomohiro Suzuki, Kashihara-shi (JP)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, Osaka (JP)

(21) Appl. No.: 11/797,425

(22) Filed: May 3, 2007

(30) Foreign Application Priority Data
May 15, 2006 (JP) 2006-135088

(51) Int. Cl. G05F 1/00

(52) U.S. Cl. 323/284

(57) ABSTRACT

There are provided a resistor R2 arranged in parallel with a resistor R1 that produces a feedback signal indicating a value of an output current to a load 7 and, in a control circuit device 6, a voltage changing circuit 68 that changes a reference potential applied to the inverting input terminal of an error amplifier 64. Thus, when the electric power of a DC power source 1 decreases, by changing the reference potential applied to the error amplifier 64 and the resistance of a resistor that detects the value of the output current to the load 7, it is possible to reduce the electric power consumption of the resistor and thereby prolong a lifespan of the DC power source.

This nonprovisional application claims priority under 35 U.S.C. §119(a) on Patent Application No. 2006-135088 filed in Japan on May 15, 2006, the entire contents of which are hereby incorporated by reference.

### BACKGROUND OF THE INVENTION

1. Field of the Invention

The present invention relates to power supply circuit devices that step up or step down an input voltage supplied from a DC power source to supply it to a load, and to electronic apparatuses provided with such power supply circuit devices.

2. Description of Related Art

In recent years, white light-emitting diodes (white LEDs) that are excellent in durability, luminous efficiency, and space-saving, etc., have come to be used as one of the illumination light sources (backlights or frontlights) of liquid crystal display devices (LCDs) incorporated in portable electronic apparatuses such as cellular phones, PDAs (personal digital assistants), and digital cameras. The brightness of a white LED increases with an increasing amount of current flowing therethrough. However, the white LEDs need a relatively high forward voltage of about 4 V, and the forward voltages of these white LEDs vary widely.

A plurality of white LEDs are typically used as an illumination light source such as a backlight of a liquid crystal display device. The plurality of white LEDs used as the illumination light source are connected in series so as to achieve the uniformity in the brightness thereof. Thus, a DC (direct-current) voltage that is higher than a DC voltage supplied from a battery built in the portable electronic apparatus is required to drive the white LEDs as the illumination light source.

In addition, along with the miniaturization of communications apparatuses, which is made possible by the development in communications technology, distribution of video to the portable electronic apparatuses has become popular. Some of these portable electronic apparatuses that can receive video incorporate, for example, a digital tuner. To drive the digital tuner, however, a voltage of 30 to 40V is required as a voltage source. Thus, the portable electronic apparatuses having such capability also require a DC voltage that is higher than a DC voltage supplied from a battery built therein.

It is for this reason that the portable electronic apparatuses described above use a stepping-up chopper regulator as a stepping-up power supply circuit device to step up a DC voltage supplied from, for example, a lithium ion battery built therein. Furthermore, a stepping-up chopper regulator drive method is usually adopted therein, in which, to make uniform the brightness of the white LEDs that serve as the illumination light source of the liquid crystal display device, the white LEDs are connected in series to pass the same current therethrough.

FIG. 12 shows a configuration of such a power supply circuit device that serves as a stepping-up chopper regulator. The power supply circuit device shown in FIG. 12 is provided with a DC (direct-current) power source 1 such as a lithium ion battery, an input capacitor 2 connected in parallel with the DC power source 1, a coil 3 having one end connected to the node between the input capacitor 2 and a positive terminal (a supplied voltage side) of the DC power source 1, a diode 4 whose anode is connected to the other end of the coil 3, the diode 4 serving as a rectifying element, an output capacitor 5 connected to the cathode of the diode 4, and a control circuit device 60 that is formed as an IC mounted in a single package and that performs stepping-up operation by storing energy in or releasing energy from the coil 3. The sides of the DC power source 1, the input capacitor 2, and the output capacitor 5 opposite from the supplied voltage (the sides thereof on the negative side of the DC power source 1) are grounded.

One end of a load 7 is connected to the cathode of the diode 4 so that a voltage stepped up by this power supply circuit device is applied to the load 7. To the other end of the load 7, a resistor RI having one end grounded is connected at the other end thereof. To the node at which the load 7 and the resistor R1 are connected together, a feedback signal input terminal FB of the control circuit device 60 is connected. The control circuit device 60 has an input-voltage input terminal Vi that is connected to the supplied voltage side of the DC power source 1, a control terminal Vsw that is connected to the node between the coil 3 and the diode 4 so as to control the amount of current flowing through the coil 3, and a ground terminal GND that is grounded.

The control circuit device 60 includes an output switching transistor Tr1 (a power transistor Tr1) formed as an NPN transistor having a collector connected to the control terminal Vsw and an emitter connected to the ground terminal GND, a constant voltage circuit 61 that transforms a DC voltage supplied from the DC power source 1 through the input-voltage input terminal Vi to a constant DC voltage to be applied to the different blocks provided in the control circuit device 60, and a control circuit 620 that changes a voltage to be fed to the base of the power transistor Tr1. The control circuit 620 includes a reference voltage circuit 63 that produces a reference potential Vref, an error amplifier 64 that receives, at the non-inverting input terminal thereof, a feedback signal fed through the feedback signal input terminal FB and receives, at the inverting input terminal thereof, the reference potential Vref derived from the reference voltage circuit 63, an oscillation circuit 65 that outputs an oscillating signal serving as a reference waveform for producing a PWM signal, a PWM comparator 66 that receives an output from the error amplifier 64 at the inverting input terminal thereof and receives the oscillating signal outputted from the oscillation circuit 65 at the non-inverting input terminal thereof, and a drive circuit 67 that turns the power transistor Tr1 ON/OFF by giving a signal to the base of the power transistor Tr1 based on the output from the PWM comparator 66.

In the power supply circuit device provided with such a control circuit device 60 configured as described above, when the power transistor Tr1 is turned ON by the drive circuit 67, a current from the DC power source 1 passes through the coil 3, whereby energy is stored in the coil 3. When the power transistor Tr1 is turned OFF by the drive circuit 67, the energy stored in the coil 3 is released, whereby back electromotive force appears in the coil 3.

The back electromotive force appearing in the coil 3 is added to the input voltage supplied from the DC power source 1, and charges the output capacitor 5 via the diode 4. That is, the voltage appearing at that side of the coil 3 at which the coil 3 is connected to the diode 4 is smoothed by the diode 4 and the output capacitor 5. By repeating the operations described above, stepping-up operation is performed, resulting in an appearance of an output voltage across the output capacitor 5. This output voltage makes an output current flow through the load 7. In a case where a white LED is used as the load 7, the output current flows through the white LED, and thereby makes it emit light.

As a result of the output current that flows through the load 7 flowing also through the resistor R1, a voltage obtained by multiplying a current value of this output current by the resistance of the resistor R1 is inputted as a feedback signal to the feedback signal input terminal FB of the control circuit device 60, and is then fed to the non-inverting input terminal of the error amplifier 64. In the error amplifier 64, a difference between the reference potential Vref derived from the reference voltage circuit 63 and the potential of the feedback signal is obtained. Then, an output signal according to the difference thus obtained is inputted to the inverting input terminal of the PWM comparator 66.

The PWM comparator 66 compares a sawtooth oscillating signal outputted from the oscillation circuit 65 with the output signal of the error amplifier 64. As a result of comparison, during a period in which the voltage level of the output signal of the error amplifier 64 is higher than the signal level of the oscillating signal outputted from the oscillation circuit 65, a PWM signal of the PWM comparator 66 takes an L (Low) level; during a period in which the voltage level of the output signal of the error amplifier 64 is lower than the signal level of the oscillating signal outputted from the oscillation circuit 65, the PWM signal of the PWM comparator 66 takes an H (High) level.

The drive circuit 67 receives the resultant PWM signal of the PWM comparator 66, and thereby controls the ON/OFF state of the power transistor Tr1 with a duty ratio commensurate with the PWM signal thus received. That is, when the PWM signal of the PWM comparator 66 takes an H level, the drive circuit 67 turns the power transistor Tr1 ON by supplying a predetermined base voltage to the power transistor Tr1. When the PWM signal of the PWM comparator 66 is turned to an L level, the drive circuit 67 turns the power transistor Tr1 OFF by stopping the supply of the base voltage to the power transistor Tr1.

In a case where such a power supply circuit device is incorporated in the portable electronic apparatus described above, it is necessary to prolong the lifespan of the DC power source 1, such as a lithium ion battery, built in the portable electronic apparatus. To prolong the lifespan of the DC power source such as a DC (direct-current) battery, the power supply circuit device adjusts the output electric power. As a power supply circuit device that adjusts the output electric power, there has been proposed a power supply circuit device that reduces the electric power consumption by changing control operation for switching an switching element according to how heavy a load connected to the output side is (see JP-A-2005-287260).

When ON/OFF state control of the power transistor Tr1 is performed in the power supply circuit device shown in FIG. 12, stepping-up operation is performed in such a way that the signal level of a feedback signal inputted to the feedback signal input terminal FB becomes equal to the reference potential Vref. That is, an output current lo to the load 7 is stabilized to a current obtained by dividing the reference potential Vref by the resistance r1 of the resistor R1, as in the equation below. Thus, for example, suppose that the reference potential Vref is set to 1 V and the output current lo to the load 7 is set to 20 mA. Then, the resistance r1 of the resistor R1 is 50 Ω.

Io=Vref/r1

Incidentally, variations in brightness of the white LEDs used as the load 7 depend on variations in the reference potential Vref derived from the reference voltage circuit 63. For the reasons associated with, for example, the chip manufacturing process, the higher the reference potential Vref, the smaller the range of variation of the reference potential Vref. However, the higher the reference potential Vref, the greater the electric power loss in the resistor R1. This affects the lifespan of the battery used as the DC power source 1 in the power supply circuit device used in the portable electronic apparatus or the like.

The technique disclosed in JP-A-2005-287260 mentioned above prevents reduction in power supply efficiency associated with an attempt to reduce the switching loss produced as a result of the oscillating frequency becoming high in light load conditions in a resonance-type power supply circuit device. By contrast, in a self-excited power supply circuit device shown in FIG. 12, the lifespan of the battery used as the DC power source 1 can be prolonged by reducing the electric power loss in the resistor R1 that produces a feedback signal for setting the amount of current flowing through the load 7.

### SUMMARY OF THE INVENTION

In view of the conventionally experienced problems described above, an object of the present invention is to provide power supply circuit devices that can reduce the electric power consumption of a resistor that measures a value of current passing through a load.

To achieve the above object, according to one aspect of the present invention, a power supply circuit device includes: a voltage transforming circuit that is connected to a DC power source; a rectifying circuit that is connected to the voltage transforming circuit; a first switching element that is connected to the voltage transforming circuit and that adjusts an electric power to be outputted to the rectifying circuit by performing switching; a drive circuit that controls an ON/OFF state of the first switching element; a current detecting circuit that detects a current flowing through a load connected to the rectifying circuit; a PWM signal producing circuit that produces a PWM signal for controlling ON/OFF state control performed by the drive circuit by comparing, with a reference value, a signal level of a current detection signal indicating a value of the current detected by the current detecting circuit; a reference value changing circuit that changes the reference value and feeds the resultant reference value to the PWM signal producing circuit; and a resistance changing circuit that changes a resistance of the current detecting circuit. Here, when the reference value fed from the reference value changing circuit is decreased, the resistance changing circuit reduces the resistance of the current detecting circuit.

According to the present invention, it is possible to decrease the reference value fed from the reference value changing circuit and make the resistance changing circuit reduce the resistance of the current detecting circuit. This makes it possible to reduce the electric power consumption of the current detecting circuit. Moreover, by making the state detecting circuit change the reference value fed to the PWM signal producing circuit and the resistance of the current detecting circuit based on the electric power of the DC power source, it is possible to reduce the electric power consumption of the current detecting circuit when the electric power of the DC power source decreases. This helps prolong the lifespan of the DC power source. Furthermore, after a decrease in the amount of electric power of the DC power source is detected, by changing the reference value fed to the PWM signal producing circuit and the resistance of the current detecting circuit when the power supply circuit device is turned ON again, it is possible to smoothly change the brightness of an LED when it is used as the load.

### BRIEF DESCRIPTION OF THE DRAWINGS

FIG. 1 is a block diagram showing the internal configuration of a power supply circuit device according to first and second embodiments;

FIG. 2 is a timing chart showing the states of signals of relevant portions to illustrate the operation of a PWM comparator;

FIG. 3 is a block diagram showing an example of the configuration of the power supply circuit device according to the first embodiment;

FIG. 4 is a block diagram showing the internal configuration of a power supply circuit device according to a third embodiment;

FIG. 5 is a block diagram showing the internal configuration of a power supply circuit device according to a fourth embodiment;

FIG. 6 is a circuit diagram showing the configuration of an external signal detecting circuit provided in the power supply circuit device shown in FIG. 5;

FIG. 7 is a block diagram showing the internal configuration of a power supply circuit device according to a fifth embodiment;

FIG. 8 is a circuit diagram showing the configuration of a state detecting circuit provided in the power supply circuit device shown in FIG. 7;

FIG. 9 is a block diagram showing the internal configuration of a power supply circuit device according to a sixth embodiment;

FIG. 10 is a block diagram showing the internal configuration of a power supply circuit device according to a seventh embodiment;

FIG. 11 is a block diagram showing another example of the configuration of the power supply circuit device according to the seventh embodiment; and

FIG. 12 is a block diagram showing the internal configuration of a conventional power supply circuit device.

### DETAILED DESCRIPTION OF PREFERRED EMBODIMENTS

### First Embodiment

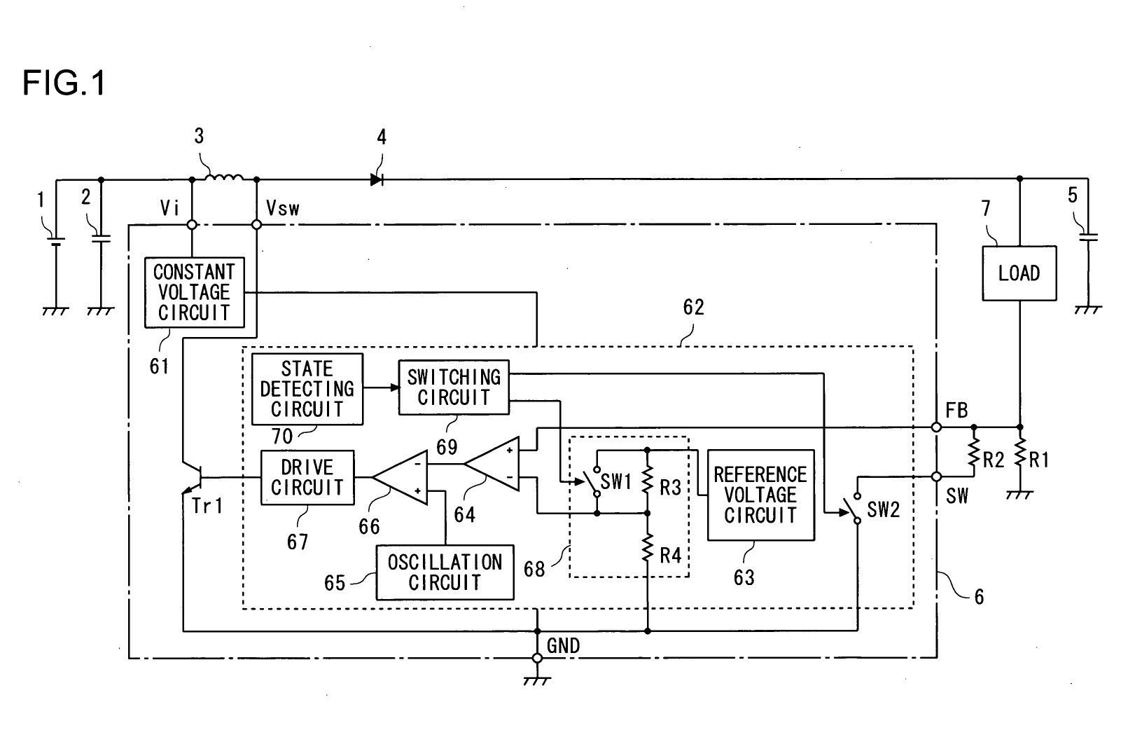

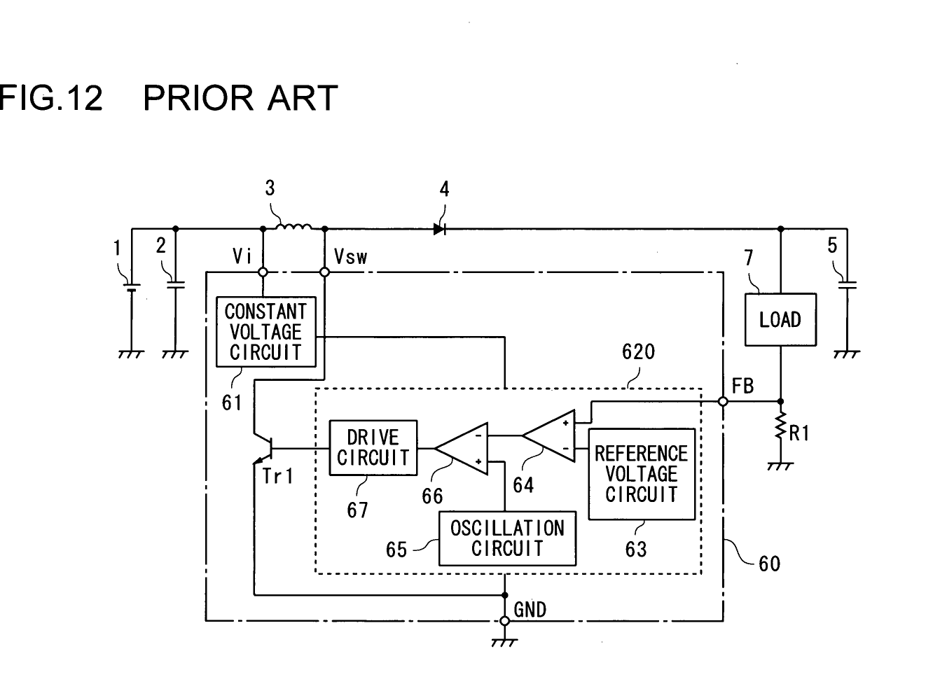

A first embodiment of the present invention will be described with reference to the drawings. FIG. 1 is a block diagram showing the internal configuration of a power supply circuit device of this embodiment. In FIG. 1, such circuit blocks as are used for the same purposes as in the conventional power supply circuit device shown in FIG. 12 are identified with the same reference characters, and their detailed descriptions will not be repeated.

As is the case with the power supply circuit device shown in FIG. 12, the power supply circuit device shown in FIG. 1 includes a DC (direct-current) power source 1, an input capacitor 2, a coil 3, a diode 4, an output capacitor 5, and a resistor R1, and supplies a stepped-up output voltage to a load 7. The power supply circuit device shown in FIG. 1 further includes a control circuit device 6 that switches between energy storage in and energy release from the coil 3. The control circuit device 6 includes, like a control circuit device 60 of the power supply circuit device shown in FIG. 12, a power transistor Tr1, a constant voltage circuit 61, an input-voltage input terminal Vi, a control terminal Vsw, a feedback signal input terminal FB, a ground terminal GND, and a control circuit 62 corresponding to a control circuit 620 of the power supply circuit device shown in FIG. 12.

The control circuit 62 includes, like the control circuit 620 of the power supply circuit device shown in FIG. 12, a reference voltage circuit 63, an error amplifier 64, an oscillation circuit 65, a PWM comparator 66, and a drive circuit 67. Additionally, the control circuit 62 includes a voltage changing circuit 68 that changes a value of the reference potential Vref derived from the reference voltage circuit 63, a switch SW2 that changes the resistance of a resistor used for measuring an output current to the load 7, a switching circuit 69 that controls the ON/OFF state of a switch SW1, which will be described later, provided in the voltage changing circuit 68 and the ON/OFF state of the switch SW2, and a state detecting circuit 70 that detects a state of the DC power source 1.

Furthermore, one end of a resistor R2 arranged in parallel with the resistor R1 is connected to the node between the load 7 and the resistor R1. The control circuit device 6 includes a resistance switching terminal SW to which the other end of the resistor R2 is connected. The switch SW2 is connected to the resistance switching terminal SW at one end thereof and to a ground terminal GND at the other end thereof. The voltage changing circuit 68 includes: a resistor R3 that receives, at one end thereof, the reference potential Vref derived from the reference voltage circuit 63; a resistor R4 that is connected, at one end thereof, to the other end of the resistor R3 and is grounded at the other end thereof via the ground terminal GND; and the switch SW1 that is connected to the resistor R3 at both ends thereof so as to be arranged in parallel with the resistor R3. The inverting input terminal of the error amplifier 64 is connected to the node between the resistors R3 and R4 and the switch Sw1.

Hereinafter, operation of the power supply circuit device configured as described above will be described. This power supply circuit device is so configured that, although the overall control operation performed by the control circuit device 62 for stepping-up operation is common, ON/OFF of the switches SW1 and SW2 is switched depending on whether the power supply circuit device performs operation (hereinafter “normal operation”) during which electric power supplied from the DC power source 1 is sufficiently high or operation (hereinafter “low-power operation”) during which electric power supplied from the DC power source 1 is low. The following description begins with an explanation of the overall control operation of the power supply circuit device which is common to normal operation and low-power operation.

### Overall Control Operation

As is the case with the power supply circuit device configured as shown in FIG. 12, in the power supply circuit device configured as shown in FIG. 1, when the power transistor Tr1 is turned ON, the current from the DC power source 1 flows through the power transistor Tr1 via the coil 3, whereby energy is stored in the coil 3. During this period, the current is supplied from the output capacitor 5 to the load 7. When the power transistor Tr1 is turned OFF, the energy stored in the coil 3 is released, whereby back electromotive force appears in the coil 3. In this way, the voltage to be fed to the load 7 via the diode 4 is stepped up. At this point, the stepped-up voltage is fed to the load 7 and to the capacitor 5, whereby the current is supplied to the load 7 and the capacitor 5 is charged.

When the stepping-up operation is performed in the coil 3 by repeatedly turning the power transistor Tr1 ON/OFF, a feedback signal obtained by converting the output current flowing through the load 7 into a voltage signal is inputted to the feedback signal input terminal FB of the control circuit device 62. The error amplifier 64 performs subtraction on the signal level of the feedback signal inputted to the non-inverting input terminal thereof and the reference potential applied from the voltage changing circuit 68 to the inverting input terminal thereof, and then outputs a differential signal commensurate with the value obtained by the subtraction to the inverting input terminal of the PWM comparator 66.

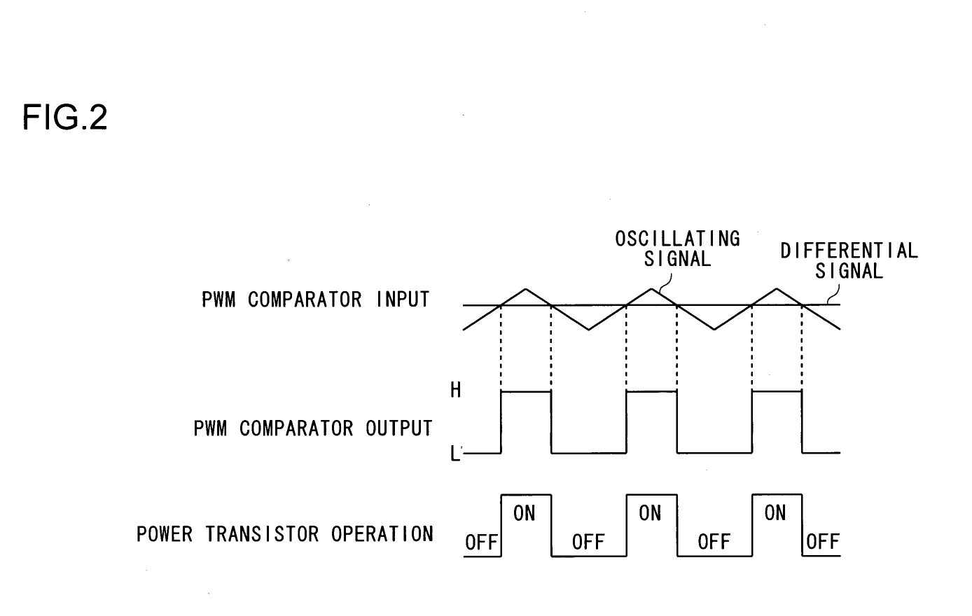

In the PWM comparator 66, as shown in FIG. 2, the signal level of a sawtooth oscillating signal outputted from the oscillation circuit 65 is compared with the signal level of the differential signal outputted from the error amplifier 64. As a result, during a period in which the voltage level of the output signal of the error amplifier 64 is higher than the signal level of the oscillating signal outputted from the oscillation circuit 65, the PWM signal of the PWM comparator 66 takes an L level; during a period in which the voltage level of the output signal of the error amplifier 64 is lower than the signal level of the oscillating signal outputted from the oscillation circuit 65, the PWM signal of the PWM comparator 66 takes an H level.

In this way, in the PWM comparator 66, pulse width modulation is performed according to the signal level of the differential signal outputted from the error amplifier 64. Upon receipt of the PWM signal that is obtained as a result of the pulse width modulation performed by the PWM comparator 66 and is then fed to the drive circuit 67, the drive circuit 67 turns the power transistor Tr1 OFF when the PWM signal is at L level, and turns the power transistor Tr1 ON when the PWM signal is at H level.

As a result of the relevant blocks operating as described above, switching control of the power transistor Tr1 is performed in such a way that a desired output current is supplied to the load 7. Hereinafter, normal operation (high-precision mode) and low-power operation (high-efficiency mode) in the power supply circuit device performing the above-described overall control operation are each explained.

### Normal Operation

Now, normal operation of the power supply circuit device performed when electric power of the DC power source 1 is sufficiently high will be described. When the state detecting circuit 70 detects that the electric power of the DC power source 1 is sufficiently high, the detection result is fed to the switching circuit 69. The switching circuit 69 turns ON the switch SW1 provided in the voltage changing circuit 68 and holds the switch SW2 in the OFF position.

As a result, a feedback signal, which is a voltage signal appearing across the resistor R1, is inputted to the non-inverting input terminal of the error amplifier 64 via the feedback signal input terminal FB, and the reference potential Vref derived from the reference voltage circuit 63 is inputted to the inverting input terminal of the error amplifier 64 via the switch SW1. Thus, an output current lo flowing through the load 7 is given by equation below, where r1 represents the resistance of the resistor R1.

Io=Vref/r1

In this case, when a plurality of white LEDs connected in series are used as the load 7, to reduce variations in brightness of these white LEDs, the reference potential Vref is set to a large value (e.g., 1 V) in the manufacturing process, for example, of a semiconductor chip that forms the power supply circuit device. This helps reduce variations in the reference potential Vref of the semiconductor chip, and thereby offer high-precision control of an output current to the load 7.

For example, suppose that the reference potential Vref is set to 1 V and the output current Io flowing through the load 7 is set to 20 mA. Then, the resistance r1 of the resistor R1 is 1V/20 mA=50 Ω, and the electric power loss in the resistor R1 in normal operation is given by Vref×Io=Vref²/r1. Thus, as described above, in a case where the reference potential Vref and the output current Io flowing through the load 7 are set to 1 V and 20 mA, respectively, an electric power loss in the resistor R1 is 20 mW.

### Low-Power Operation

Now, low-power operation of the power supply circuit device, which is performed to reduce the electric power consumption when electric power of the DC power source 1 is low, will be described. If the state detecting circuit 70 detects a decrease in the electric power of the DC power source 1 during normal operation performed in the manner as described above, the detection result is fed to the switching circuit 69. Upon receipt of the detection result from the state detecting circuit 70, the switching circuit 69 turns OFF the switch SW1 provided in the voltage changing circuit 68 and turns the switch SW2 ON so as to perform low-power operation.

As a result, a feedback signal, which is a voltage signal appearing in a circuit in which the resistors R1 and R2 are connected in parallel, is inputted to the non-inverting input terminal of the error amplifier 64 via the feedback signal input terminal FB, and a potential divided by the resistors R3 and R4 provided in the voltage changing circuit 68 is inputted to the inverting input terminal of the error amplifier 64. Thus, the output current lo flowing through the load 7 is given by equation below, where r1 to r4 represent resistances of the resistors R1 to R4, respectively.

Io=Vref×r4×(r1+r2)/((r3+r4)×r1×r2)

In this case, the resistances of the resistors R2 to R4 are set so that the amount of output current Io flowing through the load 7 is equal to the amount of output current Io flowing therethrough in normal operation. Thus, for example, suppose that the ratio of the resistance r3 of the resistor R3 to the resistance r4 of the resistor R4 is set to 9:1. Then, the reference potential outputted from the voltage changing circuit 68 is given by Vref×(r4/(r3 +r4)), that is, 0.1×Vref. The resistance of a combination of the resistors R1 and R2 is set in such a way that the output current to the load 7 is prevented from gradually decreasing as a result of the reference potential inputted to the inverting input terminal of the error amplifier 64 having decreased to one tenth of that observed in normal operation. That is, the resistance of the resistor R2 is set so that the resistance of a combination of the resistors R1 and R2 given by r1×r2/(r1+r2) becomes equal to a resistance given by 0.1×r1.

Thus, for example, in a case where the reference potential Vref and the output current Io flowing through the load 7 in normal operation are set to 1 V and 20 mA respectively as described above, the resistance r1 of the resistor R1 is set to 50 Ω and the resistance r2 of the resistor R2 is set to 5.6 Ω. This makes constant the value of current flowing through the load 7 even when the reference potential outputted from the voltage changing circuit 68 is changed to 0.1 V by the switching circuit 69. Furthermore, in low-power operation, the current loss in the resistors R1 and R2 is given by 1/10×Vref×Io, that is, in the example described above, the current loss therein is 0.1 V×20 mA=2 mW. Thus, as compared with normal operation, low-power operation makes it possible to reduce the electric power loss by 18 mW.

With this configuration, when electric power of the DC power source 1 decreases, it is possible to reduce the electric power consumption of a combination of the resistors R1 and R2 that produce a feedback signal without changing the output current to the load 7. This makes it possible to prolong the lifespan of a lithium battery, for example, serving as the DC power source 1.

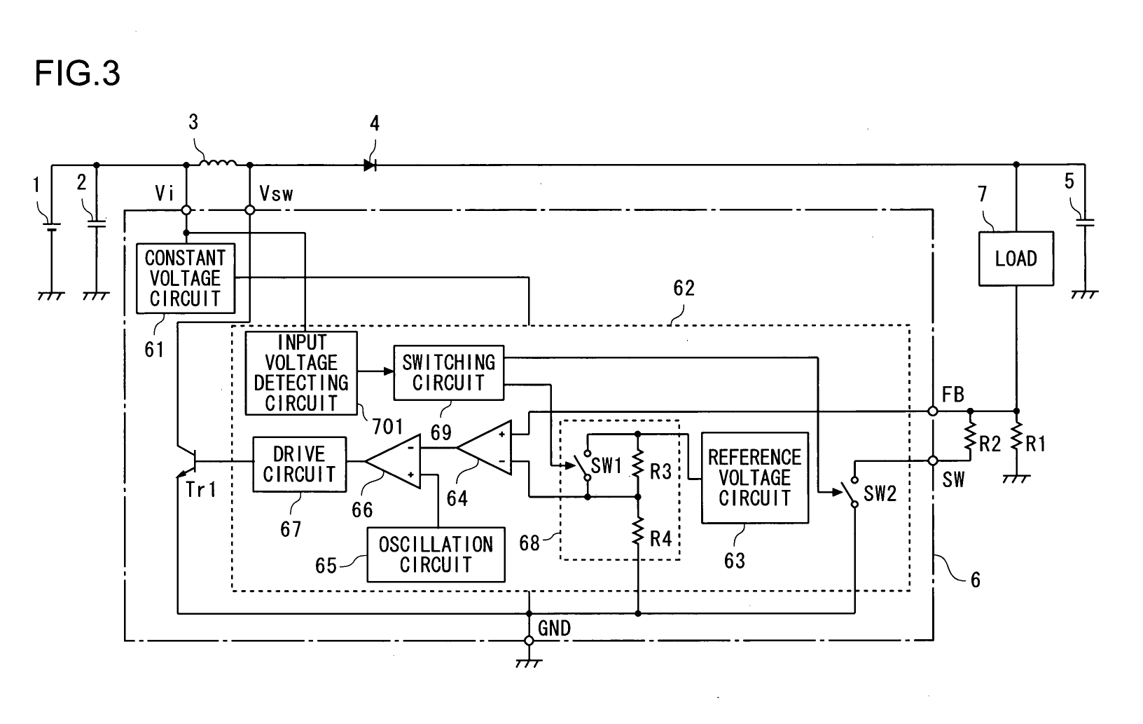

Alternatively, in this embodiment, as shown in FIG. 3, the state detecting circuit 70 may be built as an input voltage detecting circuit 701 that is connected to the input-voltage input terminal Vi so as to measure an input voltage from the DC power source 1. In this case, the input voltage detecting circuit 701 compares the input voltage inputted to the input-voltage input terminal Vi from the DC power source 1 with a predetermined voltage value, and, when the input voltage from the DC power source 1 becomes lower than the predetermined voltage value, gives an instruction to the switching circuit 68 so as to switch normal operation to low-power operation.

### Second Embodiment

A second embodiment of the present invention will be described with reference to the drawings. As is the case with the power supply circuit device of the first embodiment, a power supply circuit device of this embodiment is configured as shown in the block diagram of FIG. 1. In the following description, only differences from the power supply circuit device of the first embodiment are explained, and the explanations of such circuit blocks as are found also in the first embodiment will not be repeated as already given there.

Unlike the power supply circuit device of the first embodiment, when performing low-power operation, the power supply circuit device of this embodiment makes an output current to a load 7 smaller than that in normal operation. That is, suppose that an output current flowing through the load 7 in normal operation is Io, and an output current flowing through the load 7 in low-power operation is K×Io (0<K<1). Then, the relationship among the resistances r1 to r4 of the resistors R1 to R4 is given by the following equation.

r4×(r1+r2)/((r3+r4)×r2)=K

As described above, by reducing the amount of output current flowing through the load 7 in low-power operation, it is possible to reduce the electric power consumption of a combination of the resistors R1 and R2. Here, the resistances of the resistors R3 and R4 are made to have the same relationship as their counterparts in the power supply circuit device of the first embodiment, and the resistance of the resistor R2 in relation to the resistance of the resistor R1 is made greater than the resistance of the resistor R2 of the power supply circuit device of the first embodiment, so that the amount of output current supplied to the load 7 in low-power operation can be reduced.

Thus, for example, in a case where the reference potential Vref derived from the reference voltage circuit 63 is set to 1 V and the current Io flowing through the load 7 in normal operation is set to 20 mA, the resistance r1 of the resistor R1 is 50 Ω and the electric power loss in the resistor R1 in normal operation is 20 mW. In this case, suppose that the ratio of the resistance r3 of the resistor R3 to the resistance r4 of the resistor R4 is set to 9:1. Then, the reference potential outputted from the voltage changing circuit 68 in low-power operation is 0.1×Vref=0.1 V. Also, suppose that an output current of K x Io=(¾)×20 mA=15 mA flows through the load 7 in low-power operation. Then, the resistance of a combination of the resistors R1 and R2 is set to 6.7 Ω, that is, the resistance r2 of the resistor R2 is set to 7.7 Ω.

By setting the resistances r1 to r4 of the resistors R1 to R4 as described above, in low-power operation, a reference potential of 0.1 V is inputted from a voltage changing circuit 68 to the inverting input terminal of an error amplifier 64, and the current flowing through the load 7 is reduced from 20 mA, which is set in normal operation, to 15 mA. As a result, in low-power operation, the current loss in a combination of the resistors R1 and R2 is Vref×(r4/(r3+r4))×(K×Io)=0.1V×15 mA=1.5 mW. That is, as compared with when normal operation is performed, the electric power loss is reduced by 18.5 mW. As described above, by switching to low-power operation, it is possible to further prolong the lifespan of a lithium battery, for example, serving as the DC power source 1. That is, in this embodiment, in a case where white LEDs are used as the load 7, although the brightness of the white LEDs is reduced in low-power operation due to a decrease in the output current, it is possible to prolong the lifespan of the DC power source 1.

### Third Embodiment

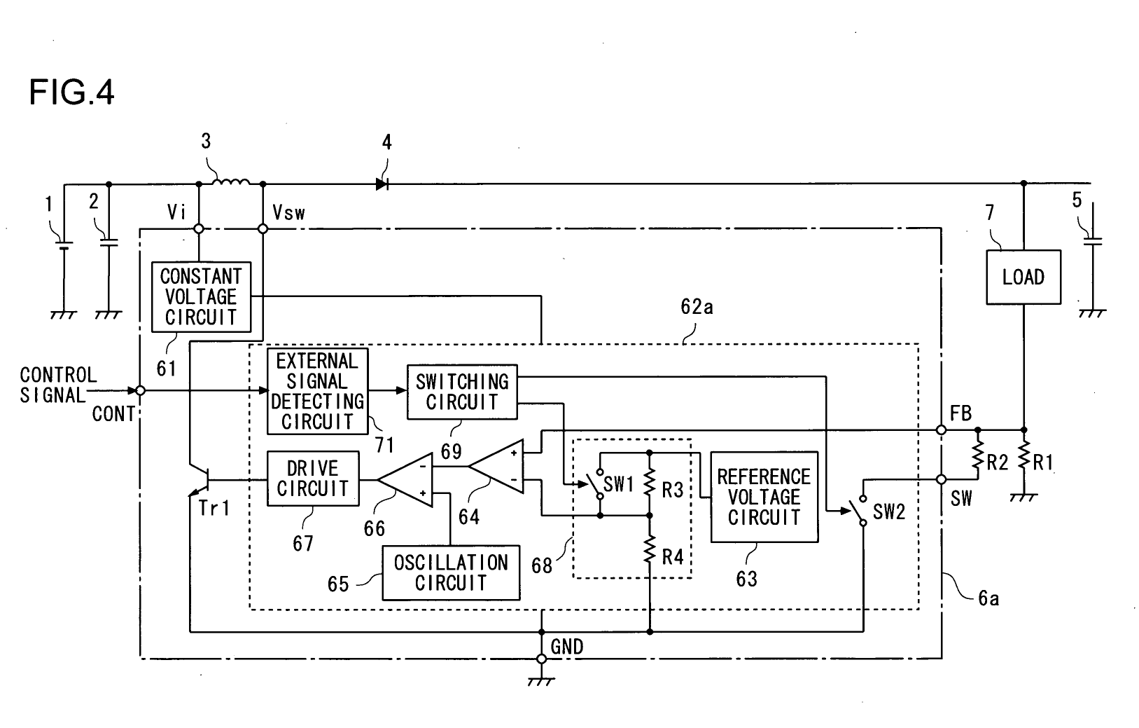

A third embodiment of the present invention will be described with reference to the drawings. FIG. 4 is a block diagram showing the internal configuration of a power supply circuit device of this embodiment. In FIG. 4, such circuit blocks as are used for the same purposes as in the power supply circuit device shown in FIG. 1 are identified with the same reference characters, and their detailed descriptions will not be repeated.

Unlike the power supply circuit device of the first embodiment (see FIG. 1), the power supply circuit device of this embodiment has a configuration in which switching between normal operation and low-power operation is performed based on a control signal fed from outside. Thus, as shown in FIG. 4, a control circuit device 6a has a control signal input terminal CONT to which a control signal fed from outside is inputted. Additionally, a control circuit 62a provided in the control circuit device 6a includes, instead of a state detecting circuit 70, an external signal detecting circuit 71 that operates a switching circuit 69 based on the control signal inputted thereto via the control signal input terminal CONT. In other respects, the power supply circuit device of this embodiment is the same as that of the first embodiment.

With this configuration, switching between normal operation and low-power operation is performed based on a control signal fed from outside. That is, when a control signal indicating normal operation is inputted to the control signal input terminal CONT, the external signal detecting circuit 71 provided in the control circuit 62a detects the issuance of the normal operation instruction. The switching circuit 69, upon receipt of the detection result given thereto, turns the switch SW1 ON and the switch SW2 OFF, whereby the normal operation for high-precision mode is performed.

On the other hand, when a control signal indicating low-power operation is inputted to the control signal input terminal CONT, the external signal detecting circuit 71 provided in the control circuit 62a detects the issuance of the low-power operation instruction. The switching circuit 69, upon receipt of the detection result, turns the switch SW1 OFF and the switch SW2 ON, whereby the low-power operation for high-efficiency mode is performed.

### Fourth Embodiment

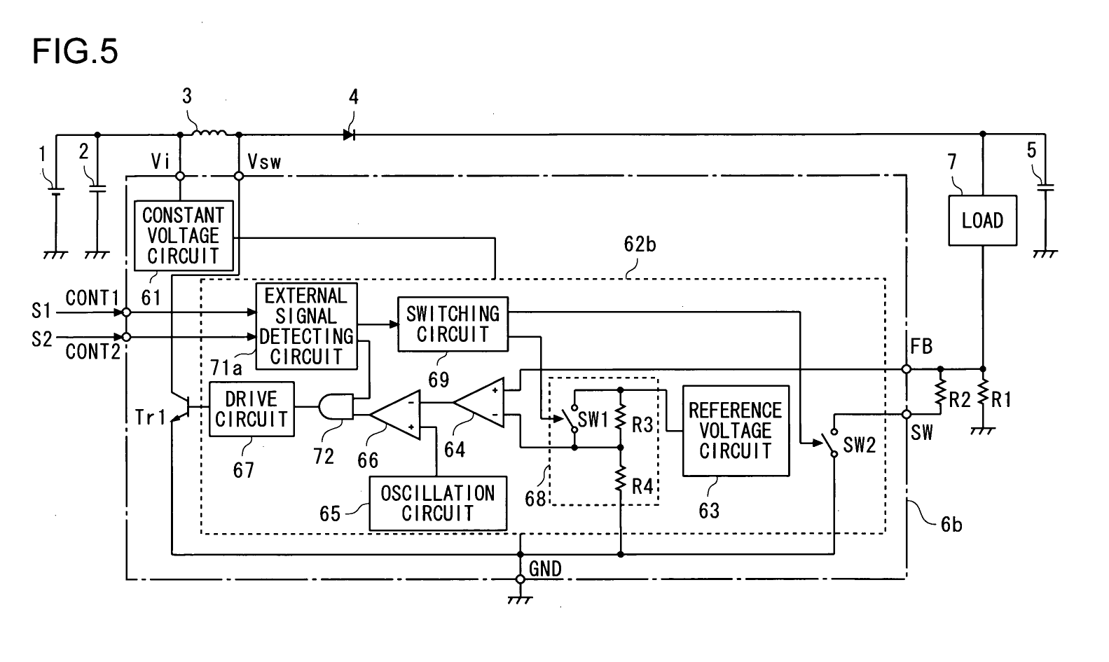

A fourth embodiment of the present invention will be described with reference to the drawings. FIG. 5 is a block diagram showing the internal configuration of a power supply circuit device of this embodiment. In FIG. 5, such circuit blocks as are used for the same purposes as in the power supply circuit device shown in FIG. 4 are identified with the same reference characters, and their detailed descriptions will not be repeated.

Unlike the power supply circuit device of the third embodiment (see FIG. 4), based on a control signal fed from outside, the power supply circuit device of this embodiment not only performs switching between normal operation and low-power operation but also controls the ON/OFF state of a control circuit device 6b shown in FIG. 5. That is, as shown in FIG. 5, the control circuit device 6b has control signal input terminals CONT1 and CONT2 to which control signals S1 and S2 are respectively inputted, and an external signal detecting circuit 71a provided in the control circuit 62b produces, from the inputted control signals S1 and S2, a signal for controlling the ON/OFF state of a drive circuit 67′ and a signal for controlling a switching circuit 69. Furthermore, the control circuit 62b includes an AND circuit 72 that receives a PWM signal from the PWM comparator 66 and a signal from the external signal detecting circuit 71 a and produces an output to the drive circuit 67.

In the following description, explanations will be given of operations of the power supply circuit device configured as described above, the operations being controlled based on the levels of the control signals S1 and S2. To begin with, the control signals S1 and S2 are each a binary signal that shifts between an H level and an L level, and a combination of the levels of the control signals S1 and S2 serves as an outside instruction indicating one of the following three states: (1) normal operation (driving in high-precision mode), (2) low-power operation (driving in high-efficiency mode), and (3) OFF state.

When the control signal S1 is turned to an H level and the control signal S2 is turned to an L level, this indicates normal operation described under (1) above. That is, when the control signal S1 is turned to an H level and the control signal S2 is turned to an L level, the external signal detecting circuit 71a outputs an H level signal to the AND circuit 72 and controls the switching circuit 69 so as to perform normal operation. This makes the switching circuit 69 turn the switch SW1 ON and the switch SW2 OFF, and a PWM signal from the PWM comparator 66 is fed to the drive circuit 67 via the AND circuit 72.

When the control signal S1 is turned to an H level and the control signal S2 is turned to an H level, this indicates low-power operation described under (2) above. That is, when the control signals S1 and S2 are both turned to an H level, the external signal detecting circuit 71a outputs an H level signal to the AND circuit 72 and controls the switching circuit 69 so as to perform low-power operation. This makes the switching circuit 69 turn the switch SW1 OFF and the switch SW2 ON, and a PWM signal from the PWM comparator 66 is fed to the drive circuit 67 via the AND circuit 72.

When the control signal S1 is turned to an L level and the control signal S2 is turned to an L level, this indicates OFF state described under (3) above. That is, when the control signals S1 and S2 are both turned to an L level, the external signal detecting circuit 71a outputs an L level signal to the AND circuit 72. This makes the AND circuit 72 inhibit the PWM comparator 66 from feeding a PWM signal to the drive circuit 67. As a result, the power transistor Tr1 is kept OFF.

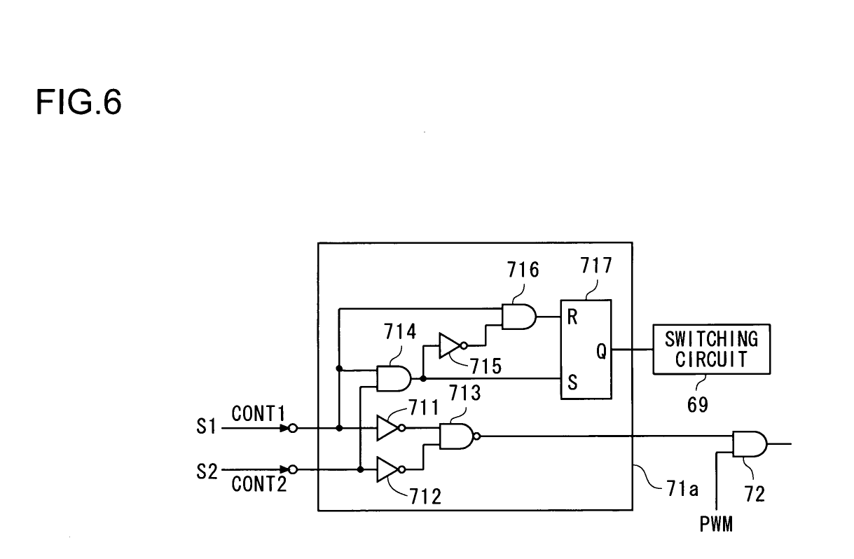

FIG. 6 shows an example of the configuration of the external signal detecting circuit 71a provided in the control circuit device 6b of the power supply circuit device that operates as described above. As shown in the circuit diagram of FIG. 6, the external signal detecting circuit 71a includes inverters 711 and 712 to which the control signals S1 and S2 are respectively inputted, a NAND circuit 713 that receives outputs from the inverters 711 and 712 and produces an output to the AND circuit 72, an AND circuit 714 to which the control signals S1 and S2 are inputted, an inverter 715 that inverts an output from the AND circuit 714, an AND circuit 716 to which an output from the inverter 715 and the control signal S1 are inputted, and a flip-flop 717 that receives, at the set terminal thereof, an output from the AND circuit 714 and receives, at the reset terminal thereof, an output from the AND circuit 716. An output from the flip-flop 717 is fed to the switching circuit 69.

In the external signal detecting circuit 71a configured as described above, when the control signals S1 and S2 are turned to an H level and to an L level, respectively, or when the control signals S1 and S2 are both turned to an H level, an H level output is fed from the NAND circuit 713 to the AND circuit 72. As a result, a PWM signal from the PWM comparator 66 is fed to the drive circuit 67. On the other hand, when the control signals S1 and S2 are both turned to an L level, an L level output is fed from the NAND circuit 713 to the AND circuit 72. As a result, a PWM signal from the PWM comparator 66 is inhibited from being fed to the drive circuit 67.

When the control signals S1 and S2 are turned to an H level and to an L level, respectively, an output of the AND circuit 714 is turned to an L level. As a result, both the inputs to the AND circuit 716 take an H level, making the AND circuit 716 input an H level to the reset terminal of the flip-flop 717. This makes the flip-flop 717 feed an L level signal to the switching circuit 69, so that the switching circuit 69 turns the switch SW1 ON and the switch SW2 OFF.

When the control signals S1 and S2 are both turned to an H level, an output of the AND circuit 714 is turned to an H level. As a result, one of the inputs of the AND circuit 716 takes an L level, and an H level is inputted from the AND circuit 714 to the set terminal of the flip-flop 717. This makes the flip-flop 717 feed an H level signal to the switching circuit 69, so that the switching circuit 69 turns the switch SW1 OFF and the switch SW2 ON.

### Fifth Embodiment

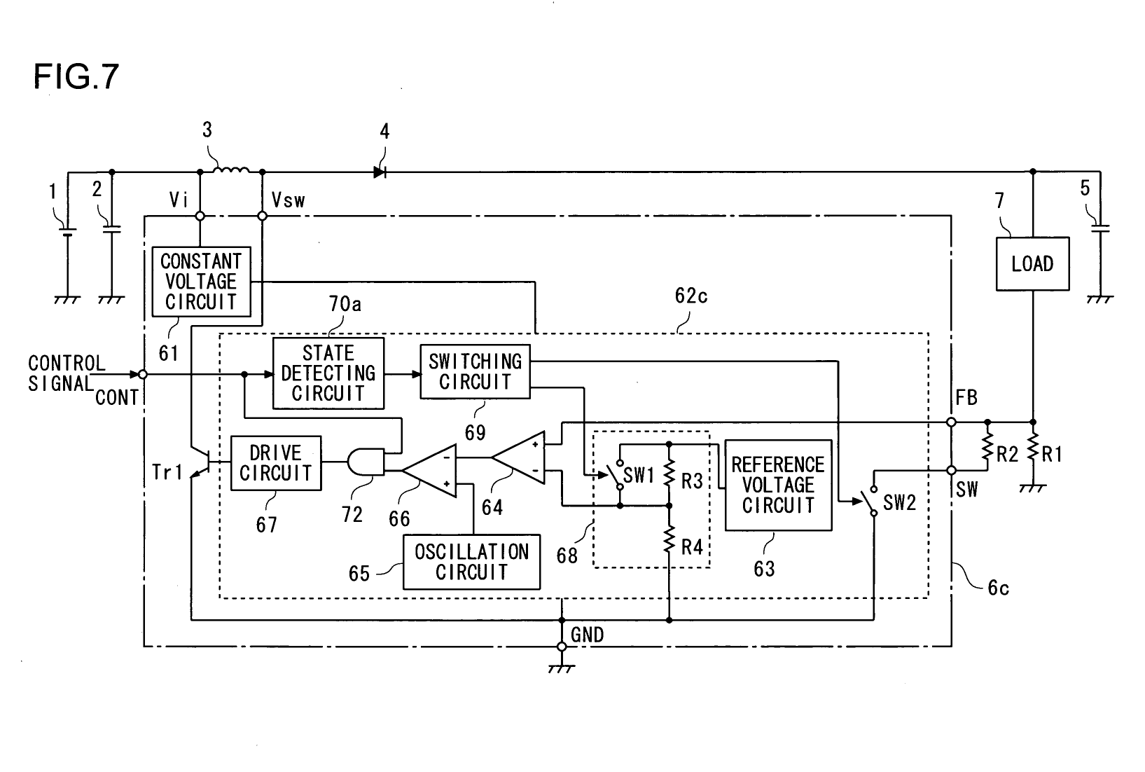

A fifth embodiment of the present invention will be described with reference to the drawings. FIG. 7 is a block diagram showing the internal configuration of a power supply circuit device of this embodiment. In FIG. 7, such circuit blocks as are used for the same purposes as in the power supply circuit device shown in FIG. 1 are identified with the same reference characters, and their detailed descriptions will not be repeated.

Unlike the power supply circuit device of the first embodiment (see FIG. 1), in the power supply circuit device of this embodiment, a control circuit device 6c has a control signal input terminal CONT to which a control signal fed from outside is inputted. In a control circuit 62c of the control circuit device 6c, the control signal inputted to the control signal input terminal CONT is fed to a state detecting circuit 70a that detects a state of a DC power source 1, and an AND circuit 72 is provided that receives the control signal inputted to the control signal input terminal CONT and a PWM signal from the PWM comparator 66 and that produces an output to a drive circuit 67.

In the power supply circuit device configured as described above, when the control signal inputted to the control signal input terminal CONT takes an H level and the PWM signal from the PWM comparator 66 is permitted to be fed to the drive circuit 67, if the state detecting circuit 70a detects that the electric power of the DC power source 1 is sufficiently high, it gives a normal operation instruction to the switching circuit 69. Thus, the switching circuit 69 turns the switch SW1 ON and the switch SW2 OFF.

Unlike the first embodiment, even when the state detecting circuit 70a detects that the electric power of the DC power source 1 has decreased, normal operation is continuously performed without switching to low-power operation so long as the control signal inputted to the control signal input terminal CONT remains at H level. When the control signal inputted to the control signal input terminal CONT is turned to an L level, the PWM signal from the PWM comparator 66 is inhibited from being fed to the drive circuit 67. At this point, the state detecting circuit 70a gives a low-power operation instruction to the switching circuit 69. Thus, the switching circuit 69 turns the switch SW1 OFF and the switch SW2 ON.

Thereafter, even after the control signal inputted to the control signal input terminal CONT is turned to an H level, the switching circuit 69 holds the switch SW1 in the OFF position and the switch SW2 in the ON position, so that low-power operation is continuously performed until the state detecting circuit 70a detects that the electric power of the DC power source 1 has become sufficiently high. On the other hand, if normal operation is continuously performed while the electric power of the DC power source 1 remains sufficiently high, when the control signal inputted to the control signal input terminal CONT is turned to an L level, the switching circuit 69 holds the switch SW1 in the ON position and the switch SW2 in the OFF position.

In the power supply circuit device configured as described above, unlike the power supply circuit device of the first embodiment, switching to low-power operation is performed when a control signal indicating OFF of the power supply circuit device is fed from outside after a decrease in the electric power of the DC power source 1 is detected. That is, switching of operation is performed while the power supply circuit device is OFF, and the operation state is changed when the power supply circuit device is turned ON. Thus, in a case where a white LED is used as a load 7, the brightness of the white LED, or the load 7, can be changed smoothly when normal operation is switched to low-power operation.

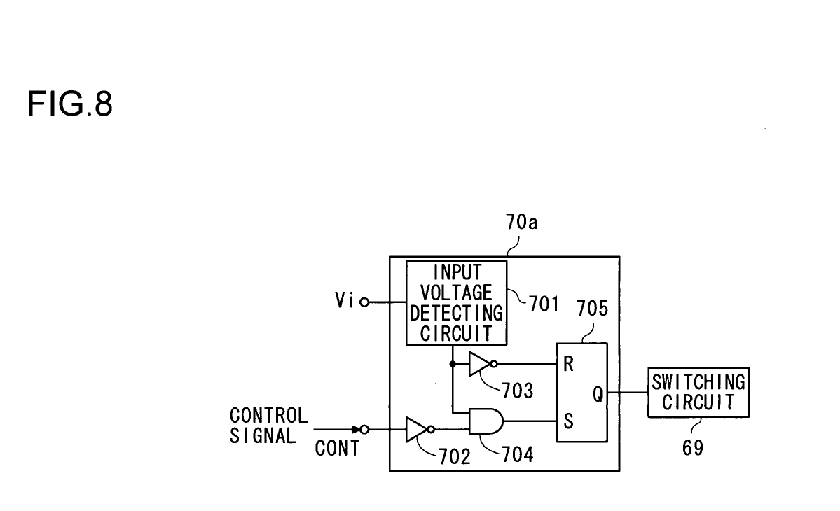

Here, an example of the configuration of the state detecting circuit 70a provided in the control circuit device 6c of the power supply circuit device described above is shown in FIG. 8. In the example of the configuration shown in FIG. 8, the state detecting circuit 70a measures an input voltage inputted to an input-voltage input terminal Vi from the DC power source 1, thereby detecting the state of the DC power source 1.

The state detecting circuit 70a shown in FIG. 8 includes an input voltage detecting circuit 701 connected to the input-voltage input terminal Vi, an inverter 702 that inverts a control signal inputted to the control signal input terminal CONT, an inverter 703 that inverts a signal outputted from the input voltage detecting circuit 701, an AND circuit 704 to which an output of the inverter 702 and a signal outputted from the input voltage detecting circuit 701 are inputted, and a flip-flop 705 that receives, at the reset terminal thereof, an output from the inverter 703 and receives, at the set terminal thereof, an output from the AND circuit 704. An output from the flip-flop 705 is fed to the switching circuit 69.

In the state detecting circuit 70a configured as described above, the input voltage detecting circuit 701 outputs an L level signal when the input voltage supplied from the DC power source 1 through the input-voltage input terminal Vi is higher than a predetermined voltage, and outputs an H level signal when the input voltage supplied from the DC power source 1 becomes lower than the predetermined voltage. Thus, when the input voltage supplied from the DC power source 1 is higher than the predetermined voltage and therefore an L level signal is outputted from the input voltage detecting circuit 701, the inverter 703 outputs an H level, and the AND circuit 704 outputs an L level. Accordingly, the flip-flop 705 receives an H level signal at the reset terminal thereof, and outputs an L level signal to the switching circuit 69. As a result, the switch SW1 is turned ON and the switch SW2 is turned OFF.

When the control signal inputted to the control signal input terminal CONT is at H level, the inverter 702 outputs an L level, and therefore the output of the AND circuit 704 remains at L level. Accordingly, even when the input voltage detecting circuit 701 outputs an H level signal as a result of the input voltage supplied from the DC power source 1 becoming lower than the predetermined voltage, the output of the AND circuit 704 remains at L level, and therefore the output of the flip-flop 705 remains unchanged.

At this point, when once the control signal inputted to the control signal input terminal CONT takes an L level, the AND circuit 704 outputs an H level to the set terminal of the flip-flop 705. Accordingly, the flip-flop 705 outputs an H level signal to the switching circuit 69, whereby the switch SW1 is turned OFF and the switch SW2 is turned ON. Thereafter, when the control signal inputted via the control signal input terminal CONT is turned to an H level, low-power operation is performed in the power supply circuit device.

### Sixth Embodiment

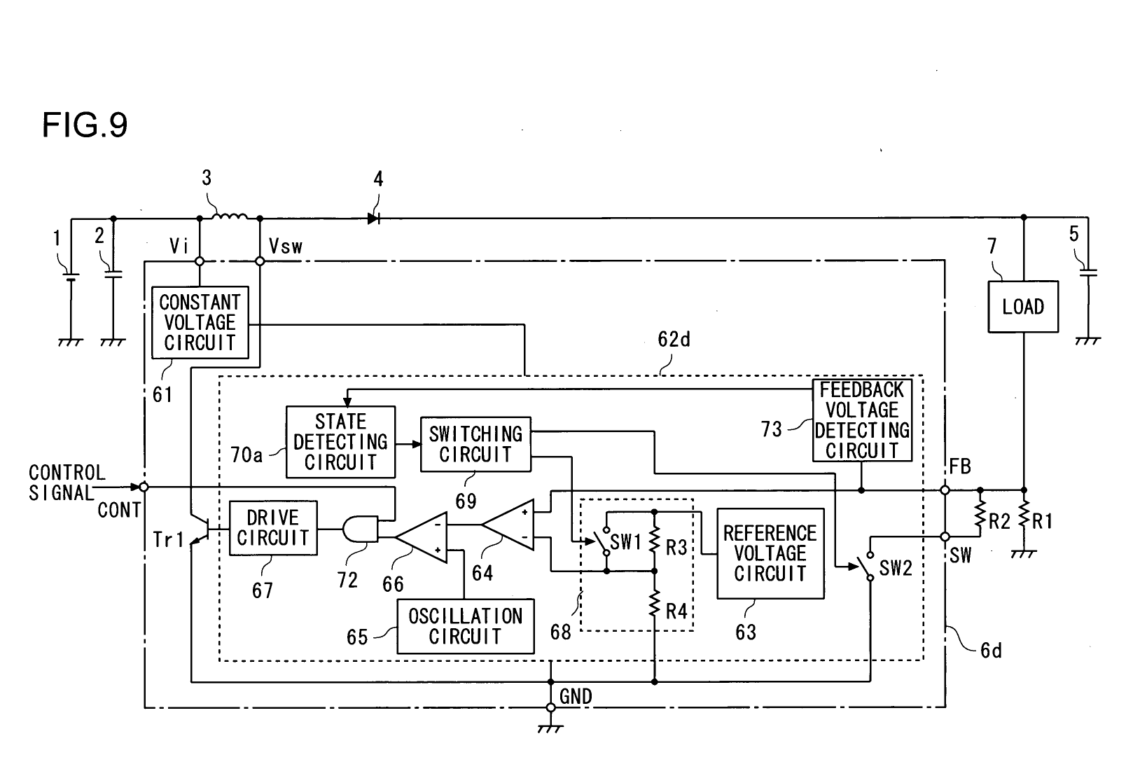

A sixth embodiment of the present invention will be described with reference to the drawings. FIG. 9 is a block diagram showing the internal configuration of a power supply circuit device of this embodiment. In FIG. 9, such circuit blocks as are used for the same purposes as in the power supply circuit device shown in FIG. 7 are identified with the same reference characters, and their detailed descriptions will not be repeated.

Unlike the power supply circuit device of the fifth embodiment (see FIG. 7), in the power supply circuit device of this embodiment, a control circuit 62d of a control circuit device 6d includes a feedback voltage detecting circuit 73 that detects the ON/OFF state of the power supply circuit device based on a feedback signal inputted to a feedback signal input terminal FB, and an output from the feedback voltage detecting circuit 73 is fed to a state detecting circuit 70a. Furthermore, unlike the power supply circuit device of the fifth embodiment, a control signal inputted to a control signal input terminal CONT is inputted only to an AND circuit 72.

In the power supply circuit device of this embodiment, instead of a control signal that is inputted to the control signal input terminal CONT in the power supply circuit device of the fifth embodiment, the detection result of the feedback voltage detecting circuit 73 is fed to the state detecting circuit 70a, so that the state detecting circuit 70a can check the ON/OFF state of the power supply circuit device. That is, according to the switching of a signal indicating the detection result of the feedback voltage detecting circuit 73, the state detecting circuit 70a operates in the same manner as it does according to the switching of the signal level of the control signal. Therefore, in the following description, only a difference from the fifth embodiment, i.e., operation of the feedback voltage detecting circuit 73, is explained.

When the control signal inputted to the control signal input terminal CONT is turned to an L level, and therefore the AND circuit 72 inhibits the PWM comparator 66 from feeding the PWM signal to the drive circuit 67, the power transistor Tr1 is kept OFF. This stops the supply of output current to the load 7, causing the reduction in the signal level of the feedback signal inputted to the feedback signal input terminal FB.

Upon detecting that the signal level of the feedback signal has reduced to a predetermined signal level, the feedback voltage detecting circuit 73 changes the signal outputted therefrom to the state detecting circuit 70a from an H level to an L level. Despite the reduction therein, if the signal level of the feedback signal is found to be higher than the predetermined signal level, the signal outputted from the feedback voltage detecting circuit 73 to the state detecting circuit 70a is kept at H level. In this way, the feedback voltage detecting circuit 73 checks the amount of output current to the load 7, thereby detecting the ON/OFF state of the power supply circuit device.

With this operation, while normal operation is performed with the control signal at H level, when the state detecting circuit 70a detects a decrease in the electric power of the DC power source 1, the control signal is turned to an L level, and thereby the power supply circuit device is turned OFF. This reduces the signal level of the feedback signal. Thereafter, when the output from the feedback voltage detecting circuit 73 is turned to an L level, normal operation is switched to low-power operation. That is, when the output from the feedback voltage detecting circuit 73 is turned to an L level after the state detecting circuit 70a detects a decrease in the electric power of the DC power source 1, the switching circuit 69 turns the switch SW1 OFF and the switch SW2 ON. Thus, with the state detecting circuit 70a having a configuration of the fifth embodiment shown in FIG. 8, instead of the control signal inputted to the control signal input terminal CONT, the output from the feedback voltage detecting circuit 73 is inputted to the inverter 702.

Incidentally, in the third to sixth embodiments, the resistances r1 to r4 of the resistors R1 to R4 may have the relationship similar to that described in the first embodiment, or the relationship similar to that described in the second embodiment. That is, by giving the resistances r1 to r4 of the resistors R1 to R4 the relationship similar to that described in the first embodiment, it is possible to reduce the electric power consumption of a combination of the resistors R1 and R2 without changing the value of the output current to the load 7 in low-power operation. Alternatively, by giving the resistances r1 to r4 of the resistors R1 to R4 the relationship similar to that described in the second embodiment, it is possible to make smaller the value of the output current to the load 7. This makes it possible to further reduce the electric power loss of a combination of the resistors R1 and R2.

In the first, fifth, or the sixth embodiment, the external signal detecting circuit 71 or 71a described in the third or fourth embodiment may be provided. That is, the external signal detecting circuit 71 may be provided to check whether normal operation or low-power operation is instructed based on the control signal fed from outside, and feed the check result to the state detecting circuit 70 or 70a so that it controls the switching circuit 69 to operate accordingly. Alternatively, the external signal detecting circuit 71a may be provided to check whether normal operation, low-power operation, or OFF state is instructed based on two control signals S1 and S2 fed from outside, and feed the check result to the state detecting circuit 70 or 70a so that it controls the switching circuit 69 to operate accordingly.

### Seventh Embodiment

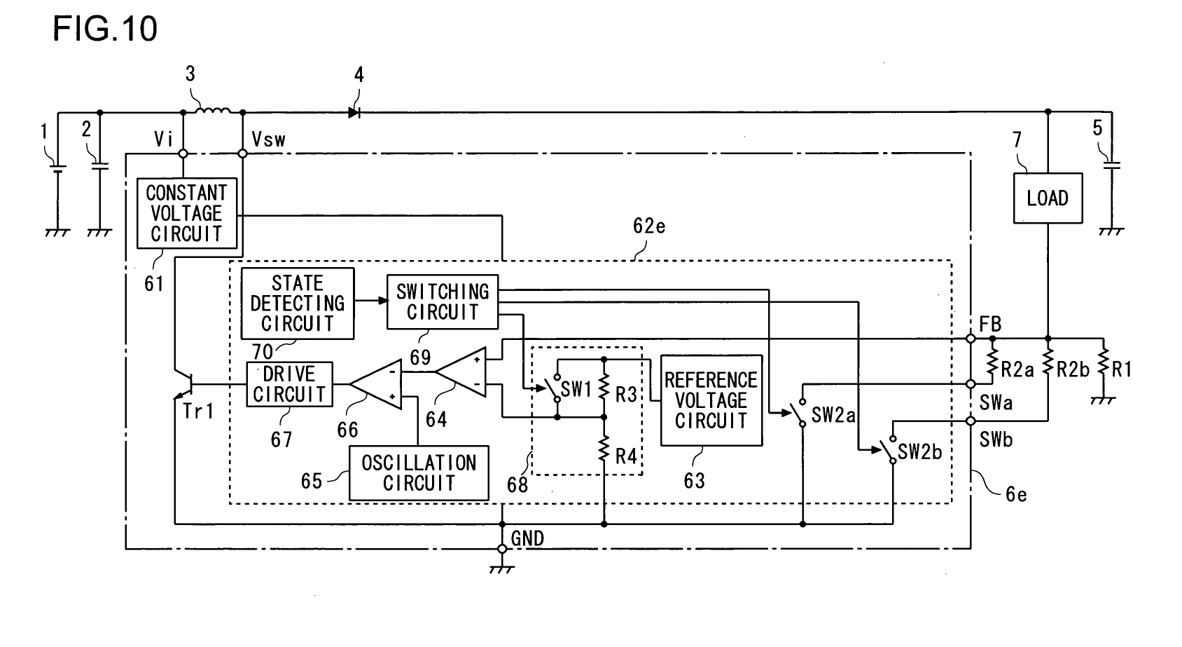

A seventh embodiment of the present invention will be described with reference to the drawings. FIG. 10 is a block diagram showing the internal configuration of a power supply circuit device of this embodiment. In FIG. 10, such circuit blocks as are used for the same purposes as in the power supply circuit device shown in FIG. 1 are identified with the same reference characters, and their detailed descriptions will not be repeated.

The power supply circuit device of this embodiment differs from the power supply circuit device of the first embodiment (see FIG. 1) in that two resistors R2a and R2b, each having one end connected to the node between a resistor R1 and the load 7, are provided so as to be arranged in parallel with the resistor R1, a control circuit device 6e has resistance switching terminals SWa and SWb connected to the other ends of the resistors R2a and R2b respectively, and the control circuit 62e has switches SW2a and SW2b connected, at their respective one ends, to the resistance switching terminals SWa and SWb respectively, and connected, at their respective other ends, to the ground terminal GND.

In this configuration, the resistance of the resistor R2a is set to a value at which, in a case where the switch SW2a is turned ON so as to form a circuit in which the resistors R1 and R2a are arranged in parallel, when the reference potential to be applied to the inverting input terminal of the error amplifier 64 is lowered in the voltage changing circuit 68 by turning the switch SW1 OFF, the same output current as that flowing through the load 7 in normal operation flows through the load 7. On the other hand, the resistance of the resistor R2b is set to a value at which, in a case where the switch SW2b is turned ON so as to form a circuit in which the resistors R1 and R2b are arranged in parallel, when the reference potential to be applied to the inverting input terminal of the error amplifier 64 is lowered in the voltage changing circuit 68 by turning the switch SW1 OFF, an output current smaller than that flowing through the load 7 in normal operation flows through the load 7.

That is, for example, in a case where the reference potential Vref derived from the reference voltage circuit 63 is set to 1 V and the current Io flowing through the load 7 in normal operation is set to 20 mA, suppose that the ratio of the resistance r3 of the resistor R3 to the resistance r4 of the resistor R4 is set to 9:1. Then, the resistance r2a of the resistor R2a is set to 5.6 Ω. Furthermore, suppose that an output current of 15 mA flows through the load 7 when the switch SW2b is turned ON. Then, the resistance r2b of the resistor R2b is set to 7.7 Ω.

As described above, the resistance r2b of the resistor R2b is set to a value that is greater than the value of the resistance r2a of the resistor R2a. When the switch SW2a is turned ON, the same output current as that flowing through the load 7 in normal operation flows through the load 7; when the switch SW2b is turned ON, an output current smaller than that flowing through the load 7 in normal operation flows through the load 7. When the state detecting circuit 70 detects that the electric power of the DC power source 1 has decreased below a first threshold value, it gives an instruction to the switching circuit 69 so as to turn the switch SW1 OFF and the switch SW2a ON. At this point, the switch SW2b is turned OFF. Thereafter, when the state detecting circuit 70 detects that the electric power of the DC power source 1 has decreased below a second threshold value that is smaller than the first threshold value, it gives an instruction to the switching circuit 69 so as to turn the switch SW1 OFF and the switch SW2b ON. At this point, the switch SW2a is turned OFF.

With the configuration described above, when the electric power of the DC power source 1 has decreased below the first threshold value, the reference potential inputted to the inverting input terminal of the error amplifier 64 is lowered to reduce the electric power loss of a combination of the resistors R1 and R2a without changing the value of the output current to the load 7. Furthermore, when the electric power of the DC power source 1 has decreased below the second threshold value, the value of the output current to the load 7 is made smaller to further reduce the electric power loss of a combination of the resistors R1 and R2b. When configured as described above, like in the configuration of the first embodiment shown in FIG. 2, variations in the electric power of the DC power source 1 may be detected by checking variations in the input voltage inputted to the input-voltage input terminal Vi from the DC power source 1.

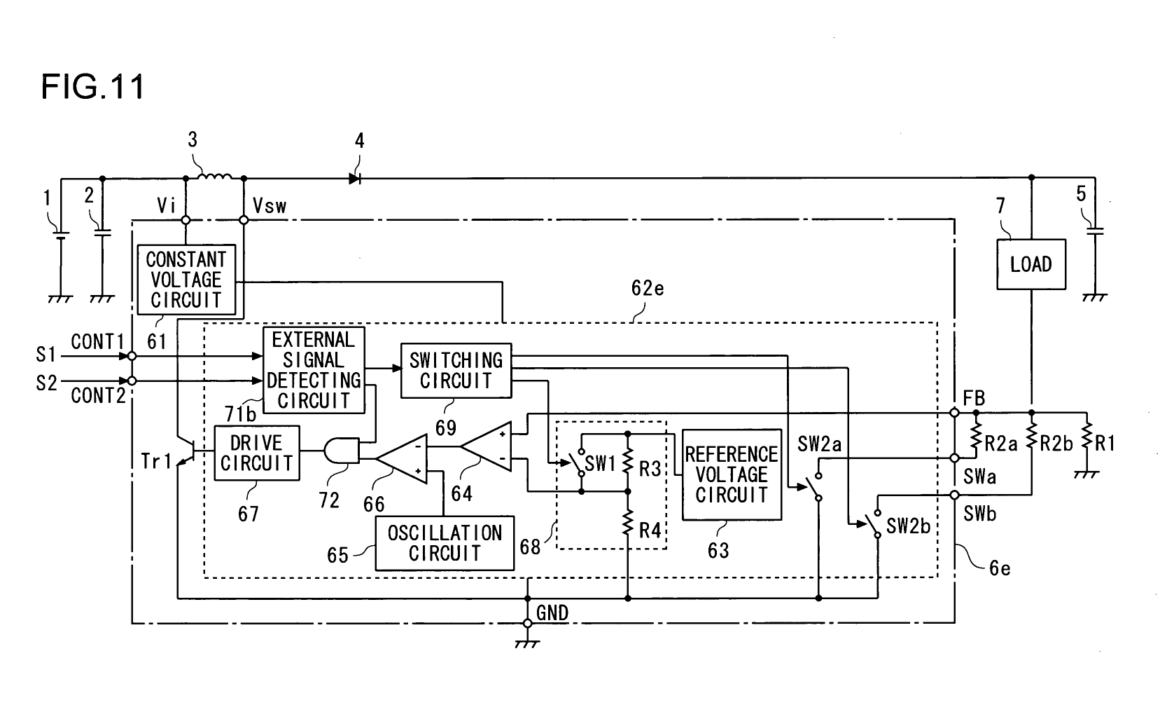

In a case where, like in this embodiment, the resistors R2a and R2b are provided, as is the case with the power supply circuit device described in the third or fourth embodiment, the switching circuit 69 may be controlled according to a control signal fed from outside so as to control the ON/OFF state of the switches SW2a and SW2b. That is, for example, in a case where, like in the fourth embodiment, control signals S1 and S2 are inputted, an external signal detecting circuit 71b to which the control signals S1 and S2 are inputted may be provided, as shown in FIG. 11, so as to control the ON/OFF state of the switches SW2a and SW2b and change the signal level of a signal inputted to the AND circuit 72 according to a combination of the control signals S1 and S2, each being a binary signal.

In this case, when the control signals S1 and S2 both take an L level, the external signal detecting circuit 71b outputs an L level signal to the AND circuit 72, whereby the PWM signal from the PWM comparator 66 is inhibited from being fed to the drive circuit 67. Any other combination of the signal levels of the control signals S1 and S2 makes the external signal detecting circuit 71b output an H level signal to the AND circuit 72, whereby the PWM signal from the PWM comparator 66 is permitted to be fed to the drive circuit 67.

When the control signal S1 takes an H level and the control signal S2 takes an L level, the switch SW1 is turned ON and the switches SW2a and SW2b are turned OFF, so that normal operation for high-precision mode is performed. When the control signals S1 and S2 both take an H level, the switch SW2a is turned ON and the switches SW1 and SW2b are turned OFF, so that low-power operation for high-efficiency mode is performed. When the control signal S1 takes an L level and the control signal S2 takes an H level, the switch SW2b is turned ON and the switches SW1 and SW2a are turned OFF, so that low-power operation for higher-efficiency mode is performed.

Incidentally, a power supply circuit device that can perform, like the one described in this embodiment, a plurality of low-power operations for changing the electric power loss in stages with a plurality of resistors having different resistance values, the resistors being arranged in parallel with the resistor R1, may be combined with the configuration described in the fifth or sixth embodiment.

The invention is applicable to power supply circuit devices serving as DC voltage chopper circuit devices that step up or down an output voltage. Moreover, the invention is applicable to power supply circuit devices that can adjust the brightness of an LED used as a load to which a voltage is outputted. Furthermore, when an LED, especially a white LED, is used as a load, the invention can be applied to a case where the white LED is used as an illumination light source of liquid crystal display devices.

What is claimed is:

1. A power supply circuit device, comprising:
a voltage transforming circuit that is connected to a direct-current power source;
a rectifying circuit that is connected to the voltage transforming circuit;
a first switching element that is connected to the voltage transforming circuit and that adjusts an electric power to be outputted to the rectifying circuit by performing switching;
a drive circuit that controls an ON/OFF state of the first switching element;
a current detecting circuit that detects a current flowing through a load connected to the rectifying circuit;
a PWM signal producing circuit that produces a PWM signal for controlling ON/OFF state control performed by the drive circuit by comparing, with a reference value, a signal level of a current detection signal indicating a value of the current detected by the current detecting circuit;
a reference value changing circuit that changes the reference value and feeds the resultant reference value to the PWM signal producing circuit; and
a resistance changing circuit that changes a resistance of the current detecting circuit,
wherein, when the reference value fed from the reference value changing circuit is decreased, the resistance changing circuit reduces the resistance of the current detecting circuit.

2. The power supply circuit device of claim 1, further comprising:
a state detecting circuit that detects an amount of electric power of the direct-current power source,
wherein, when the state detecting circuit detects a decrease in the amount of electric power of the direct-current power source, the reference value fed from the reference value changing circuit is decreased, and the resistance changing circuit reduces the resistance of the current detecting circuit.

3. The power supply circuit device of claim 2, wherein
the state detecting circuit detects the amount of electric power of the direct-current power source by checking an input voltage inputted from the direct-current power source.

4. The power supply circuit device of claim 2, wherein
after the state detecting circuit detects a decrease in the amount of electric power of the direct-current power source, the power supply circuit device is turned OFF, and, when the power supply circuit device is turned ON again, the reference value fed from the reference value changing circuit is decreased, and the resistance changing circuit reduces the resistance of the current detecting circuit.

5. The power supply circuit device of claim 4, wherein
a driving state of the power supply circuit device is checked based on a value of the current flowing through the load, the current being detected by the current detecting circuit.

6. The power supply circuit device of claim 1, further comprising:
a logic gate that makes possible/impossible an input of the PWM signal from the PWM signal producing circuit to the drive circuit based on a first control signal that controls an ON/OFF state of the drive circuit.

7. The power supply circuit device of claim 1, wherein
changing operation performed by the reference value changing circuit and the resistance changing circuit is controlled based on a second control signal fed from outside.

8. The power supply circuit device of claim 7,
wherein an ON/OFF state of the drive circuit is controlled based on the second control signal,
wherein the power supply circuit device further comprises a logic gate that makes possible/impossible an input of the PWM signal from the PWM signal producing circuit to the drive circuit based on the second control signal.

9. The power supply circuit device of claim 1, wherein
the resistance of the current detecting circuit is changed by the resistance changing circuit in a plurality of levels.

10. The power supply circuit device of claim 1, wherein
when the reference value fed from the reference value changing circuit is decreased and the resistance changing circuit reduces the resistance of the current detecting circuit, an output current flowing through the load remains unchanged.

11. The power supply circuit device of claim 1, wherein
when the reference value fed from the reference value changing circuit is decreased and the resistance changing circuit reduces the resistance of the current detecting circuit, an output current flowing through the load decreases.

12. An electronic apparatus, comprising:
a power supply circuit device that comprises:
a voltage transforming circuit that is connected to a direct-current power source;
a rectifying circuit that is connected to the voltage transforming circuit;
a first switching element that is connected to the voltage transforming circuit and that adjusts an electric power to be outputted to the rectifying circuit by performing switching;
a drive circuit that controls an ON/OFF state of the first switching element;
a current detecting circuit that detects a current flowing through a load connected to the rectifying circuit;
a PWM signal producing circuit that produces a PWM signal for controlling ON/OFF state control performed by the drive circuit by comparing, with a reference value, a signal level of a current detection signal indicating a value of the current detected by the current detecting circuit;
a reference value changing circuit that changes the reference value and feeds the resultant reference value to the PWM signal producing circuit; and
a resistance changing circuit that changes a resistance of the current detecting circuit,
the power supply circuit device that makes the resistance changing circuit reduce the resistance of the current detecting circuit when the reference value fed from the reference value changing circuit is decreased,
wherein the electronic apparatus is driven by an output voltage outputted from the power supply circuit device.

13. The electronic apparatus of claim 12, further comprising:
a light-emitting diode that is supplied with an output voltage from the power supply circuit device.
